(19) United States
(12) Patent Application Publication
(10) Pub. No.: US 2021/0264912 A1
(43) Pub. Date: Aug. 26, 2021

(54) DATA ANALYSIS METHOD, APPARATUS AND STORAGE MEDIUM BASED ON INTELLIGENT SPEECH DEVICE

(71) Applicant: BAIDU ONLINE NETWORK TECHNOLOGY (BEIJING) CO., LTD, Beijing (CN)

(72) Inventors: Wenyu WANG, Beijing (CN); Liangcheng WU, Beijing (CN); Lei ZHONG, Beijing (CN)

(73) Assignee: BAIDU ONLINE NETWORK TECHNOLOGY (BEIJING) CO., LTD, Beijing (CN)

(21) Appl. No.: 17/020,097

(22) Filed: Sep. 14, 2020

(30) Foreign Application Priority Data
Feb. 24, 2020 (CN) 2020101125616

(51) Int. Cl. G10L 15/22; G06F 16/9032; G06Q 30/06; G06F 21/36; G06K 7/14; G10L 15/30

(52) U.S. Cl. CPC G10L 15/22; G06F 16/90332; G06Q 30/0641; G10L 2015/227; G06K 7/1417; G10L 15/30; G10L 2015/228; G06F 21/36

(57) ABSTRACT

A data analysis method, an apparatus and a storage medium based on an intelligent speech device which relate to the technical field of artificial intelligence are provided. According to some embodiments, the intelligent speech device acquires feature information of the user visiting the shop; the intelligent speech device uploads user data and the identification information of the shop to the cloud based on the acquired feature information of the user visiting the shop, so that the cloud performs data analysis based on the user data and the identification information of the shop. As compared with related art, the technical solution may extend the performance of the intelligent speech device so that the intelligent speech device may constitute a business intelligence system with the cloud, achieve analysis of business data and improve an anticipation degree and a use rate of the intelligent speech device.

### CROSS-REFERENCE TO RELATED APPLICATIONS

The present application claims the priority and benefit of Chinese Patent Application No. 2020101125616, filed on Feb. 24, 2020. The disclosure of the above application is incorporated herein by reference in its entirety.

### TECHNICAL FIELD

The present disclosure relates to the field of computer technologies, particularly to the technical field of artificial intelligence, and more particularly to a data analysis method, apparatus and storage medium based on an intelligent speech device.

### BACKGROUND

With the development of intelligent home in recent years, intelligent speech devices such as intelligent speaker boxes become common intelligent devices.

Existing intelligent speech devices are mainly used in a household environment, e.g., mainly used to receive a user's speech query, and provide a corresponding service based on the user's speech query. In other words, the existing intelligent speech devices are mainly used to implement a responsive-type service. For example, the user may query for information such as weather forecast and various news and recreation through an intelligent speaker box.

As stated above, the existing intelligent speech devices has limited function.

### SUMMARY

To solve the above technical problems, the present disclosure provides a data analysis method, apparatus and storage medium based on an intelligent speech device, to enrich the performance of the intelligent speech device.

In an aspect, a data analysis method based on an intelligent speech device is propose, and the method includes: acquiring, by the intelligent speech device, feature information of a user visiting a shop; and uploading, by the intelligent speech device to a cloud, user data and identification information of the shop, based on the acquired feature information of the user visiting the shop, so that the cloud performs data analysis based on the user data and the identification information of the shop.

According to some embodiments, uploading by the intelligent speech device to the cloud user data and identification information of the shop based on the acquired feature information of the user visiting the shop includes: mining, by the intelligent speech device, the user data according to the acquired feature information of the user visiting the shop; and uploading, by the intelligent speech device to the cloud, the user data and the identification information of the shop.

According to some embodiments, acquiring by the intelligent speech device feature information of the user visiting the shop includes: acquiring, by the intelligent speech device, a face image of the user via a camera; where mining by the intelligent speech device the user data according to the acquired feature information of the user visiting the shop includes: recognizing, by the intelligent speech device, the user's gender and/or age, based on the face image of the user with a pre-trained information recognition model; and where uploading by the intelligent speech device to the cloud the user data and the identification information of the shop includes: uploading, by the intelligent speech device to the cloud, the user's gender and/or age as well as the identification information of the shop.

According to some embodiments, acquiring by the intelligent speech device feature information of the user visiting the shop includes at least one of: acquiring, by the intelligent speech device, a time of the user visiting the shop via the camera; acquiring, by the intelligent speech device, via the camera, identification information of user visiting the shop and passing by a goods shelf monitored by the camera, and the identification information of the goods shelf; acquiring, by the intelligent speech device, with the camera, a stay duration of the user visiting the shop before the goods shelf monitored by the camera, the identification information of the user and the identification information of the goods shelf; acquiring, by the intelligent speech device, query information of the user visiting the shop; or acquiring, by the intelligent speech device, the identification information of the user who visits the shop and concerns the shop by scanning a code, wherein the user who concerns the shop by scanning the code is a user who concerns the WeChat official account of the shop by scanning a two-dimensional code on a display screen.

According to some embodiments, uploading by the intelligent speech device to the cloud user data and identification information of the shop based on the acquired feature information of the user visiting the shop includes at least one of: uploading, by the intelligent speech device to the cloud, the time of the user visiting the shop and the identification information of the shop based on the time of the user visiting the shop; uploading, by the intelligent speech device to the cloud, the identification information of the user passing by the goods shelf monitored by the camera, the identification information of the goods shelf and the identification information of the shop, based on the identification information of the user visiting the shop and passing by the goods shelf monitored by the camera and identification information of the goods shelf; uploading, by the intelligent speech device to the cloud, the stay duration of the user who stays before the goods shelf monitored by the camera, the identification information of the user, the identification information of the goods shelf and the identification information of the shop, based on the stay duration of the user who visits the shop and stays before the goods shelf monitored by the camera, the identification information of the user and the identification information of the goods shelf; uploading, by the intelligent speech device to the cloud, the query information of the user and the identification information of the shop, based on the query information of the user visiting the shop; or uploading, by the intelligent speech device to the cloud, the identification information of the user who visits the shop and concerns the shop by scanning the code and the identification information of the shop, based on the identification information of the user who visits the shop and concerns the shop by scanning the code.

In another aspect, a data analysis method based on an intelligent speech device is proposed, and the method includes: receiving, by the cloud, user data and identification information of a shop uploaded by the intelligent speech device, wherein the user data is uploaded by the intelligent speech device based on acquired feature information of one or more users; and performing, by the cloud, data analysis based on the user data and the identification information of the shop.

According to some embodiments, receiving by the cloud the user data and identification information of a shop uploaded by the intelligent speech device includes at least one of: receiving, by the cloud, a user's gender and/or age uploaded by the intelligent speech device, as well as the identification information of the shop; receiving, by the cloud, a time of a user visiting the shop and the identification information of the shop uploaded by the intelligent speech device; receiving, by the cloud, the identification information of a user passing by a goods shelf monitored by the camera, identification information of the goods shelf and the identification information of the shop uploaded by the intelligent speech device; receiving, by the cloud, a stay duration of a user before the goods shelf monitored by the camera, the identification information of the user, the identification information of the goods shelf, and the identification information of the shop uploaded by the intelligent speech device; receiving, by the cloud, the query information of the user and the identification information of the shop uploaded by the intelligent speech device; or receiving, by the cloud, the identification information of the user who concerns the shop by scanning a code and the identification information of the shop uploaded by the intelligent speech device.

According to some embodiments, performing by the cloud data analysis based on the user data and the identification information of the shop includes at least one of: analyzing, by the cloud, gender distribution information of users visiting the shop within a preset time length, based on the user's gender and the identification information of the shop; analyzing, by the cloud, age distribution information of users visiting the shop within the preset time length, based on the user's age and the identification information of the shop; analyzing, by the cloud, shop-visiting distribution information of users visiting the shop within the preset time length, based on the time of the users visiting the shop and the identification information of the shop; analyzing, by the cloud, the number of users passing by the goods shelf monitored by the camera within the preset time length, based on the identification information of users passing by the goods shelf monitored by the camera, the identification information of the goods shelf and the identification information of the shop; analyzing, by the cloud, the number of users staying before the goods shelf within the preset time length based on the stay duration of the user before the goods shelf monitored by the camera, the identification information of the user, the identification information of the goods shelf and the identification information of the shop, wherein the user whose stay duration is greater than a preset duration threshold is determined to be in a stay state; analyzing, by the cloud, question distribution information of users visiting the shop within the preset time length, based on the query information of the users and the identification information of the shop; or counting, by the cloud, the number of users who visit the shop and concern the shop by scanning a code within the preset time length, based on identification information of the users who concern the shop by scanning the code and the identification information of the shop.

According to some embodiments, the method further includes: acquiring, by the cloud, operation data of the shop; and performing, by the cloud, statistics on business data of the shop based on the operation data and the received user data and the identification information of the shop.

In another aspect, an intelligent speech device is proposed, and the intelligent speech device includes: an acquisition module configured to acquire feature information of a user visiting the shop; and an uploading module configured to upload user data and the identification information of the shop to the cloud based on the acquired feature information of the user visiting the shop, so that the cloud performs data analysis based on the user data and the identification information of the shop.

In another aspect, a cloud device is proposed, and the cloud device includes: a receiving module configured to receive user data and identification information of a shop uploaded by an intelligent speech device, wherein the user data is uploaded by the intelligent speech device based on acquired feature information of one or more users; and a data analyzing module configured to perform data analysis based on the user data and the identification information of the shop.

In another aspect, a data analysis system based on an intelligent speech device is proposed. The system includes: an intelligent speech device described above and a cloud device described above.

In another aspect, an electronic device is proposed, the device includes: at least one processor; and a storage communicatively connected with the at least one processor, where the storage stores instructions executable by the at least one processor, and the instructions are executed by the at least one processor to enable the at least one processor to perform the method described above.

In another aspect, a non-transitory computer-readable storage medium storing computer instructions therein, where the computer instructions are used to cause the computer to perform the method described above.

Embodiments of the present disclosure have the following advantages or advantageous effects: the intelligent speech device acquires feature information of the user visiting the shop; the intelligent speech device uploads user data and the identification information of the shop to the cloud based on the acquired feature information of the user visiting the shop, so that the cloud performs data analysis based on the user data and the identification information of the shop. As compared with the existing art, the present disclosure can extend the performance of the intelligent speech device so that the intelligent speech device can constitute a business intelligence system with the cloud, achieve analysis of business data and improve an anticipation degree and a use rate of the intelligent speech device.

According to the present disclosure, the cloud receives the user data and the identification information of the shop uploaded by the intelligent speech device; the user data is uploaded by the intelligence speech device based on the acquired feature information of the user; the cloud performs data analysis based on the user data and the identification information of the shop. As compared with the existing art, the present disclosure can expand the performance of the intelligent speech device so that the intelligent speech device can constitute a business intelligent system with the cloud to achieve the analysis of the business data and improve the participation degree and use rate of the intelligent speech device.

Furthermore, on the side of the intelligent speech device according to the present disclosure, the intelligent speech device may also acquire the face image of the user via the camera, recognize the user's gender and/or age based on the acquired face image of the user with a pre-trained information recognition model and upload the user's gender and/or age to the cloud, thereby avoiding directly uploading the face image of the user to the cloud and effectively protecting the user's privacy.

Furthermore, the cloud according to the present disclosure may further acquire the operation data of the shop; perform statistics on business data of the shop based on the operation data and the received user data and the identification information of the shop, to directly feed back the business data to the shop's intelligent speech device or the shop's account for reference by the shop runner, thereby avoiding introduction of other business systems into the shop and effectively saving the management expenditure of the shop.

Other effects of the above optional manners will be described hereunder in conjunction with various embodiments.

### BRIEF DESCRIPTION OF THE DRAWINGS

The figures are intended to facilitate understanding the solutions, not to limit the present disclosure. In the figures,

FIG. 1 illustrates an application architecture diagram according to some embodiments of the present disclosure;

FIG. 2 illustrates a schematic diagram of a data analysis method according to some embodiments of the present disclosure;

FIG. 3 illustrates a schematic diagram of a data analysis method according to some embodiments of the present disclosure;

FIG. 4 illustrates a user shop visit distribution information graph according to some embodiments of the present disclosure;

FIG. 5 illustrates a schematic diagram of a goods shelf purchase rate according to some embodiments of the present disclosure;

FIG. 6 illustrates an ROI diagram of a shop according to some embodiments of the present disclosure;

FIG. 7 illustrates a schematic diagram of an intelligent speech device according to some embodiments of the present disclosure;

FIG. 8 illustrates a schematic diagram of a cloud according to some embodiments of the present disclosure;

FIG. 9 illustrates a schematic diagram of a system according to some embodiments of the present disclosure; and

FIG. 10 illustrates a block diagram of an electronic device for implementing a data analysis method based on an intelligent speech device according to some embodiments of the present disclosure.

### DETAILED DESCRIPTION

Exemplary embodiments of the present disclosure are described below with reference to the accompanying drawings, include various details of the embodiments of the present disclosure to facilitate understanding, and should be considered as merely exemplary. Therefore, those having ordinary skill in the art should recognize that various changes and modifications can be made to the embodiments described herein without departing from the scope and spirit of the application. Also, for the sake of clarity and conciseness, depictions of well-known functions and structures are omitted in the following description.

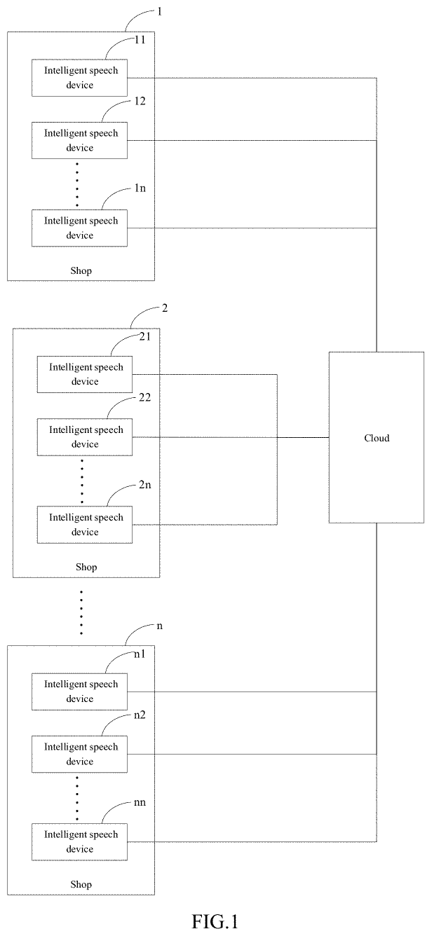

FIG. 1 illustrates an application architecture diagram according to some embodiments of the present disclosure. As shown in FIG. 1, in an application scenario of the present disclosure, a plurality of intelligent speech devices may be deployed in each shop. The intelligent speech devices according to some embodiment is used to provide a user with an intelligent question-answer service, and include a camera to acquire information, and may further include a display screen to display information to the user, e.g., display a two-dimensional code of a WeChat official account of the shop to the user. In some embodiments, for a small shop, one intelligent speech device may monitor one, two or more goods shelves. For a large shop, one goods shelf may be correspondingly provided with one, two or more intelligent speech devices to jointly monitor the goods shelf. In some embodiments, the shop is a shopping mall supermarket or a retailing specialty shop, for example, may be retailing specialty shops in chain stores so as to perform analysis on data at all points.

In the architecture diagram shown in FIG. 1, an example is taken in which there are n shops and n intelligent speech devices are disposed in each shop. Each of intelligent speech device 11, intelligent speech device 12, . . . intelligent speech device 1n, intelligent speech device 21, intelligent speech device 22, . . . , intelligent speech device 2n, . . . , intelligent speech device n1, intelligent speech device n2, . . . , intelligent speech device nn is communicated with cloud. For example, each intelligent speech device may upload data to the cloud in real time, the cloud may perform data analysis on each shop's information based on the data uploaded by each intelligent speech device. For details, reference may be made to the depictions of the following embodiments.

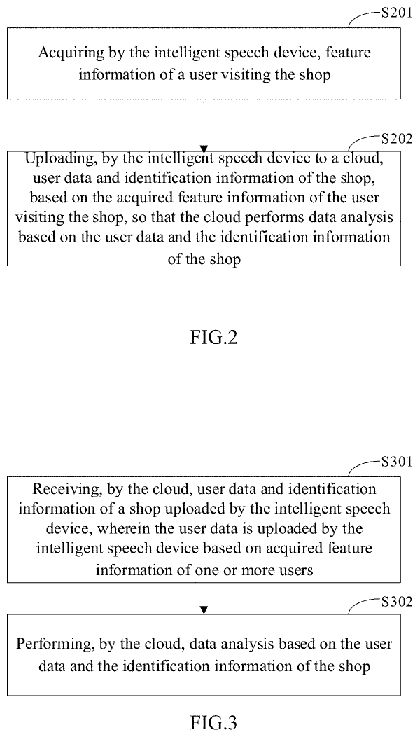

FIG. 2 illustrates a schematic diagram of a data analysis method according to some embodiments of the present disclosure. As shown in FIG. 2, the technical solution of the present disclosure regarding the data analysis method based on the intelligent speech device in some embodiments is described on the side of the intelligent speech device. As shown in FIG. 2, the data analysis method based on the intelligent speech device in some embodiments may specifically include the following steps:

S201: the intelligent speech device acquires feature information of a user visiting the shop;

S202: the intelligent speech device uploads user data and the identification information of the shop to the cloud based on the acquired feature information of the user visiting the shop, so that the cloud performs data analysis based on the user data and the identification information of the shop.

The technical solution of the present disclosure regarding data analysis method based on the intelligent speech device in some embodiments is described by taking any intelligent speech device in FIG. 1 as an example.

In a practical application scenario, after entering the shop, the user will move along the goods shelves to select articles he/she wants to buy. During the user's movement, the feature information of the user will be acquired by the camera of the intelligent speech device monitoring the goods shelf. In addition, when the user has a question regarding a certain article, he may query the intelligent speech device so that the intelligent speech device may also acquire the feature information of the user when the user queries. Furthermore, when the user wants to acquire information such as the promotion information and coupon information of the shop, he may concern the WeChat official account of the shop by scanning the two-dimensional code displayed on the display screen of the intelligent speech device. During this process, the intelligent speech device may also acquire the user's corresponding feature information. In addition to the feature information in the above cases, the intelligent speech device may further acquire all feature information of each user visiting the shop during stay in the shop, which will not be detailed herein.

Optionally, the intelligent speech device uploading user data and the identification information of the shop to the cloud based on the acquired feature information of users visiting the shop in the step S202 may include the following cases:

The first case: the user data is mined based on the feature information of the user. At this time, the corresponding step S202 that the intelligent speech device uploads user data and the identification information of the shop to the cloud based on the acquired feature information of the user visiting the shop may specifically include the following steps:

(1) the intelligent speech device mines corresponding user data according to the acquired feature information of the user visiting the shop:

(2) the intelligent speech device uploads the user data and the identification information of the shop to the cloud.

In some embodiments, the identification information of the shop may be an identification (ID) which is pre-configured for the shop and can solely identify the shop. The identification of the shop may be pre-configured duly. When the intelligent speech device of the shop uploads data to the cloud, the data will include the identification of the shop which clearly indicates the source of the intelligent speech device so that the cloud will put together the data reported by all intelligent speech devices in the shop for statistics.

At this time, correspondingly, the step S201 that the intelligent speech device acquires feature information of users visiting the shop may include: the intelligent speech device acquiring the face image of the user via the camera;

At this time, correspondingly, the step (1) that the intelligent speech device mines corresponding user data according to the acquired feature information of users visiting the shop may specifically include: the intelligent speech device recognize the user's gender and/or age based on the acquired face image of the user with a pre-trained information recognition model.

At this time, correspondingly, the step (2) the intelligent speech device uploads the user data and the identification information of the shop to the cloud may specifically include: the intelligent speech device uploads the user's gender and/or age to the cloud as well as the identification information of the shop.

Since a plurality of intelligent speech devices may be arranged in a shop, there is always one intelligent speech device in the shop that can acquire the face image of the user via a camera so long as the user visits the shop. A duly-trained information recognition model is further provided in the intelligent speech device. The face image acquired by the camera is input to the information recognition model, and the camera may output the user's age and/or gender corresponding to the face.

The information recognition model is a neural network model, which is duly trained before use. Upon training, innumerable groups of training data may be acquired, and each group of training data include a face image and annotated real gender and age. Upon training, the groups of training data are input to the information recognition model, and the information recognition model may output predicted gender and age. Then, the predicted one is compared with the real one, and if they are inconsistent, the parameters of the information recognition model are adjusted so that they become consistent. The information recognition model is trained constantly with several groups of training data until the predicted one is always consistent with the real one. Upon completion of the training, the parameters of the information recognition model are determined so that the information recognition model is determined.

It is to be appreciated that the above-mentioned information recognition model may only predict gender or age according to actual requirement, and correspondingly the information recognition model may be trained only with the gender or age upon training.

The acquired face image of the user is input to the above duly-trained information recognition model to obtain the user's gender and/or age. As such, it is feasible to upload the user's gender and/or age to the user, and not to upload the face image of the user to the cloud, which will effectively protect the user's privacy.

The second case: the user data is the feature information of the user. At this time, correspondingly the step S201 that the intelligent speech device acquires feature information of users visiting the shop may specifically include the following steps:

(a1) the intelligent speech device acquires a time of the user visiting the shop via the camera;

(b1) the intelligent speech device acquires, via the camera, identification information of user visiting the shop and passing by a goods shelf monitored by the camera, and the identification information of the goods shelf;

In some embodiments, the identification information of the user may be the identification information allocated by the intelligent speech device for the user and used to solely identify the user after the user visits the shop. For example, the intelligent speech device may configure the identification information for users sequentially from front to back with sequence numbers. Furthermore, a plurality of intelligent speech devices in a shop can work in corporation, and track all users so that different intelligent speech devices can acquire the feature information of the user corresponding to the same user identification information.

The identification information of the goods shelf is pre-configured for the goods shelf in the shop to facilitate analysis of the business operation power of the goods shelf. In practical application, to facilitate implementation, a bar code or a two-dimensional code including the identification information of the goods shelf may be stuck on the goods shelf. Within a monitoring scope of the intelligent speech device, if the bar code or two-dimensional code is scanned, the identification information of the goods shelf will be acquired.

(c1) the intelligent speech device acquires, via the camera, a stay duration of the user visiting the shop before the goods shelf monitored by the camera, the identification information of the user and the identification information of the goods shelf;

In some embodiments, the intelligent speech device further acquires the stay duration of the user, that is, when it is detected that the user stays at a certain point, the intelligent speech device may count the stay duration of the user. Meanwhile, it is also necessary to acquire the identification information of the user and the identification information of the goods shelf where the user stays.

(d1) the intelligent speech device acquires query information of the user visiting the shop;

For example, the query information is a question asked by the user to the intelligent speech device. The question may be stored by the intelligent speech device.

(e1) the intelligent speech device acquires the identification information of the user who visits the shop and concerns the shop by scanning a code. The user who concerns the shop by scanning a code is a user who concerns the WeChat official account of the shop by scanning a two-dimensional code on the display screen.

In some embodiments, the WeChat official account of the shop is displayed on the display screen of the intelligent speech device, the user may see the WeChat official account of the shop by scanning the two-dimensional code, and the user may concern the WeChat official account. After the user visits the account, he will acquire information such as online coupon information and promotional activity information of the shop. The intelligent speech device may detect the identification information of each user who scans the two-dimensional code and concerns the WeChat official account.

Furthermore, in the second case, correspondingly step S202 that the intelligent speech device uploads user data and the identification information of the shop to the cloud based on the acquired feature information of users visiting the shop may specifically include the following steps:

(a2) the intelligent speech device uploads the time of the user visiting the shop and the identification information of the shop to the cloud based on the time of the user visiting the shop;

(b2) the intelligent speech device, based on the identification information of users visiting the shop and passing by a goods shelf monitored by the camera and identification information of the goods shelf, uploads to the cloud the identification information of users passing by the goods shelf monitored by the camera, the identification information of the goods shelf and the identification information of the shop;

(c2) the intelligent speech device, based on a stay duration of the user who visits the shop and stays before the goods shelf monitored by the camera, the identification information of the user and the identification information of the goods shelf, uploads to the cloud the stay duration of the user who stays before the goods shelf monitored by the camera, the identification information of the user, the identification information of the goods shelf and the identification information of the shop;

(d2) the intelligent speech device, based on the query information of the user visiting the shop, uploads the user's query information and the identification information of the shop to the cloud; and

(e2) the intelligent speech device, based on the identification information of the user who visits the shop and concerns the shop by scanning the code, uploads the identification information of the user and the identification information of the shop to the cloud.

In this case, the user data may be the feature information of the user, namely, cases in steps (a2)-(e2) correspond respectively to cases in the above steps (a1)-(e1).

It is to be appreciated that the intelligent speech device may acquire information and report the information to the cloud in real time. Optionally, the information reported by the intelligent speech device may also include the reporting time. Alternatively, since the intelligent speech device reports the information in real time, and in the case that a communication time delay between the intelligent speech device and the cloud is able to be neglected, the cloud may also take the time of receiving the data reported by the intelligent speech device as the time for the intelligent speech device reporting data.

According to the data analysis method based on the intelligent speech data of these embodiments, the intelligent speech device acquires feature information of user visiting the shop; the intelligent speech device uploads user data and the identification information of the shop to the cloud based on the acquired feature information of the user visiting the shop, so that the cloud performs data analysis based on the user data and the identification information of the shop. As compared with the existing art, the data analysis method according to the present disclosure can extend the performance of the intelligent speech device so that the intelligent speech device can constitute a business intelligence system with the cloud, achieve analysis of business data and improve an anticipation degree and a use rate of the intelligent speech device.

FIG. 3 illustrates a schematic diagram of a data analysis method according to some embodiments of the present disclosure. As shown in FIG. 3, the technical solution of the present disclosure regarding the data analysis method based on the intelligent speech device is described on the side of the cloud. As shown in FIG. 3, the data analysis method based on the intelligent speech device according to some embodiments may specifically include the following steps:

S301: the cloud receives user data and identification information of a shop uploaded by the intelligent speech device, wherein the user data is uploaded by the intelligent speech device based on acquired feature information of one or more users; and

S302: the cloud performs data analysis based on the user data and the identification information of the shop.

The user data will not be detailed any more here, and reference may be made to the two cases disclosed by the embodiments described with reference to FIG. 2.

The cloud may receive data reported by all intelligent speech devices in each shop. For example, a chain store includes a plurality of shops, and all intelligent speech devices in each shop all need to report data to the cloud. If the statistics of information of all shops, e.g., an accumulated client flow of all shops, is required to be collected, the cloud may add up the number of clients in all shops. If statistics of the information of each shop is required to be collected, the cloud may perform analysis on the needed data according to shops in conjunction with the identification information of the shop in the received information.

Optionally, if there is only one shop, in the embodiments described with reference to FIG. 2 and the embodiments described with reference to FIG. 3, analysis of the shop's data may be implemented by removing all shops' identification information and by analyzing the received data uploaded by all intelligent speech devices.

For example, step S301 that the cloud receives user data and identification information of the shop uploaded by the intelligent speech device may specifically include at least one of:

(a3) the cloud receives the user's gender and/or age uploaded by the intelligent speech device, as well as the identification information of the shop;

(b3) the cloud receives the time of the user visiting the shop and the identification information of the shop uploaded by the intelligent speech device;

(c3) the cloud receives the identification information of users passing by a goods shelf monitored by the camera, identification information of the goods shelf and the identification information of the shop uploaded by the intelligent speech device;

(d3) the cloud receives a stay duration of the user before the shelf monitored by the camera, the identification information of the user, the identification information of the goods shelf and the identification information of the shop uploaded by the intelligent speech device;

(e3) the cloud receive the query information of the user and the identification information of the shop uploaded by the intelligent speech device; and

(f3) the cloud receives the identification information of the user who concerns the shop by scanning a code and the identification information of the shop, uploaded by the intelligent speech device.

The respective information in the above steps in steps (a3)-(f3) is respectively the same as the respective information in steps (a2)-(e2) in the embodiment shown in FIG. 2. For particulars, please refer to the relevant depictions in the embodiment with reference to FIG. 2. No details will be presented here.

Correspondingly, optionally, the step S302 that the cloud performs data analysis based on the user data and the identification information of the shop may specifically include at least one of:

(a4) the cloud analyzes gender distribution information of users visiting the shop within a preset time length, based on the user's gender and the identification information of the shop;

For example, the preset time length may be set according to specific requirement, e.g., one day, a week, a month or other time lengths may be taken, which will not be limited herein.

By means of the gender distribution information, it is possible to guide the shop runner to understand whether the shop is more appealing for males or females, then guide the shop runner to improve goods according to genders, expand more goods of users of the gender who are already attracted and meanwhile improve goods of the gender who are not yet attracted, to attract more users.

(b4) the cloud analyzes age distribution information of users visiting the shop within the preset time length, based on the user's age and the identification information of the shop;

Likewise, it is also possible to, by means of the age distribution information, guide the shop runner to improve the business policies according to the age distribution information.

(d4) the cloud analyzes shop-visiting distribution information of users visiting the shop within the preset time length, based on the time of the user visiting the shop and the identification information of the shop;

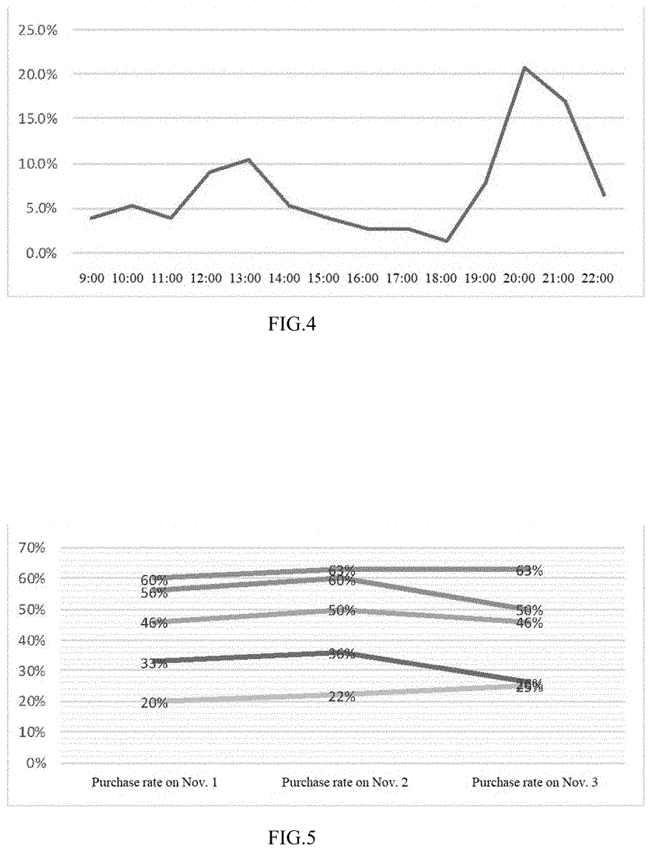

For example, FIG. 4 illustrates a user shop visit distribution information graph according to an embodiment of the present disclosure. The shop visit distribution information graph shown in FIG. 4 is a shop visit distribution information graph of users visiting a certain shop as counted in the manner stated in step (d4). It may be known from FIG. 4 that the number of users in the shop reaches a maximum value from 19:00-22:00 in one day.

(e4) the cloud analyzes the number of users passing by the goods shelf monitored by the camera within the preset time length, based on the identification information of users passing by the goods shelf monitored by the camera, the identification information of the goods shelf and the identification information of the shop;

It is possible to, through the analysis, acquire the number of users passing by each goods shelf of all shops within a preset time length, e.g., one day, thereby inferring whether the position of the goods shelf can be easily found and whether there are sufficient users that can reach the goods shelf.

(f4) the cloud analyzes the number of users staying before the goods shelf within the preset time length based on the stay duration of the user before the goods shelf monitored by the camera, the identification information of the user, the identification information of the goods shelf and the identification information of the shop, and the user whose stay duration is greater than a preset duration threshold is determined to be in a stay state;

In this step, the cloud first performs certain detection, then judge whether the stay duration in the uploaded data is greater than the preset duration threshold, and if YES, determines that the user stays at this time. In a practical application scenario, if the user stays, this indicates that the user is interested in articles on the goods shelf and there is a large possibility that he buys goods. Hence, here it is possible to analyze whether the articles on the goods shelf are very attractive to users by analyzing the number of users staying before the goods shelf within the preset duration threshold. The preset duration threshold may be selected according to experience, e.g., 5 s, 8 s, 10 s or other duration.

(g4) the cloud analyzes question distribution information of users visiting the shop within the preset time length, based on the query information of the user and the identification information of the shop;

For example, the question distribution information is used to acquire users' question and help the shop manager to improve according to the question distribution information to enhance the shop's running efficiency.

(h4) the cloud counts the number of users who visit the shop and concern the shop by scanning a code within the preset time length, based on identification information of the users who concern the shop by scanning the code and the identification information of the shop.

In some embodiments, it may be believed that the users who concern the WeChat official account of the shop by scanning the two-dimensional code have a certain viscosity. The larger the number of users who concern the WeChat official account of the shop by scanning the two-dimensional code, the larger the number of users who are interested in the shop. The shop runner may infer a degree to which the users are interested in the shop, according to the number of the users who enter the shop and concern the WeChat official account of the shop by scanning the two-dimensional code within the preset time length, to facilitate formulating next marking policy to increase user viscosity.

It is to be appreciated that the steps (a4)-(h4) are only partial data analyzed in some embodiments. In practical application, analysis of other data may also be performed according to other use data and the identification information of the shop uploaded by the intelligent speech device. No details will be presented here.

In addition, optionally, in some embodiments, the following steps may also be included:

(i) the cloud acquires the operation data of the shop;

(ii) the cloud performs statistics on business data of the shop based on the operation data and the received user data and the identification information of the shop.

Furthermore, the cloud may further send the collected business data of the shop to the shop's intelligent speech device, or send it to an account designated by the shop runner so that the shop runner obtains the shop's business data in time to facilitate further formulating an operation policy and improve the shop's sales capability.

For example, the data in step (i) may be uploaded by the shop's runner via a terminal, or uploaded by one intelligent speech device in a shop, or obtained from a designated storage address. For example, the operation data of the shop includes a sales volume of the shop within a preset time length such as one day, information of articles for sales, etc.

For example, the step (ii) that the cloud performs statistics on business data of the shop based on sales data and the received user data and the identification information of the shop may specifically be used to perform statistics of at least one of the following business data: computing a user purchase rate which is equal to daily sales volume/the number of users visiting the shop; computing a shop-client unit price which is equal to a sales volume of the shop/the number of users visiting the shop; computing a goods shelf purchase rate which is equal to a goods shelf sales volume/the number of users staying before the goods shelf; computing a goods shelf-client unit price which is equal to a goods shelf sales volume/the number of users staying before the goods shelf; computing a single user value which is equal to a sales volume of the current day/the number of users visiting the shop; computing a purchase rate of a certain product which is equal to a sales volume of the product/times of users staying before the product; computing a Return on Investment of the goods shelf, which is equal to a goods shelf sales volume/a goods shelf cost, here the cost of the goods shelf may include a manpower cost, a rental cost and a cost of articles on the goods shelf; computing a monthly shop ROI, which is equal to a shop sales volume/a shop cost, wherein the cost of the shop may include a manpower cost of the shop, a rental cost of the shop and a cost of articles of the shop.

The data needed by the statistics are all obtained from the user data and operation data.

For example, FIG. 5 illustrates a schematic diagram of a goods shelf purchase rate according to an embodiment of the present disclosure. As shown in FIG. 5, five lines identify five goods shelves, respectively. The purchase rate of each goods shelf in three days, namely, November 1, November 2 and November 3, can be seen from the figure. It is possible to, according to the analysis method, guide the shop runner to adjust goods on goods shelves with a lower purchase rate or adjust the positions of goods shelves by referring to an arrangement manner of articles on the goods shelf with a high purchase rate.

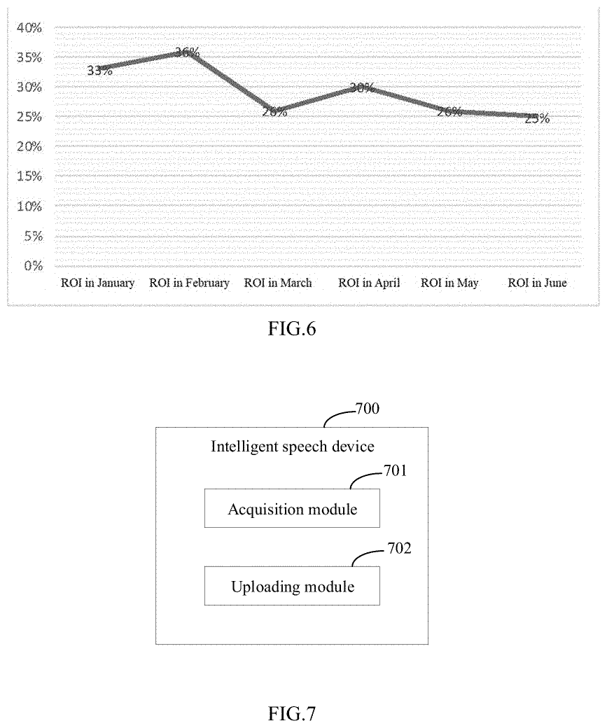

For example, FIG. 6 illustrates an ROI diagram of a shop according to an embodiment of the present disclosure. With reference to FIG. 6, it shows an example of statistics of the ROI of a certain shop from January through June. It can be seen from the figure that the ROI of the shop in February is the highest.

Other business data are not analyzed one by one. According to the above solution of the embodiments, analysis of any business data that the user wants to analyze may be obtained. No details will be presented here.

By using the technical solution described above, the shop runner needn't use other business systems to analyze the shop's operation situations; and instead, he may only deploy the intelligent speech device, upload the operation data of the shop to the cloud, and the cloud may automatically implement statistics of business data so that the operation cost can be saved effectively.

According to the data analysis method based on the intelligent speech device in these embodiments, the cloud receives the user data and the identification information of the shop uploaded by the intelligent speech device; the user data is uploaded by the intelligence speech device based on the acquired feature information of the user; the cloud performs data analysis based on the user data and the identification information of the shop. As compared with the existing art, the technical solution in these embodiments can expand the performance of the intelligent speech device so that the intelligent speech device can constitute a business intelligent system with the cloud to achieve the analysis of the business data and improve the participation degree and use rate of the intelligent speech device.

Furthermore, according to the technical solution of these embodiments, other statistics systems needn't be deployed by the shop runner so that the operation cost of the shop can be saved effectively, and the market competitiveness of the intelligent speech device can be improved.

FIG. 7 illustrates a schematic diagram of an intelligent speech device according to some embodiments of the present disclosure. With reference to FIG. 7, the intelligent speech device 700 includes: an acquisition module 701 configured to acquire feature information of a user visiting the shop; an uploading module 702 configured to upload user data and the identification information of the shop to the cloud based on the acquired feature information of the user visiting the shop, so that the cloud performs data analysis based on the user data and the identification information of the shop.

Optionally, in the intelligent speech device 700 of these embodiments, the uploading module 702 is configured to: mine corresponding user data according to the acquired feature information of the user visiting the shop; and upload the user data and the identification information of the shop to the cloud.

Optionally, in the intelligent speech device 700 of these embodiments, the acquisition module 701 is configured to acquire the face image of the user via a camera; the uploading module 702 is configured to: recognize the user's gender and/or age based on the acquired face image of the user with a pre-trained information recognition model; upload the user's gender and/or age as well as the identification information of the shop to the cloud.

Optionally, in the intelligent speech device 700 of these embodiments, the acquisition module 701 is configured to perform at least one of: acquiring a time of the user visiting the shop of the user visiting the shop through the camera; acquiring, via the camera, identification information of user visiting the shop and passing by a goods shelf monitored by the camera, and identification information of the goods shelf; acquiring, via the camera, a stay duration of the user visiting the shop before the goods shelf monitored by the camera, the identification information of the user and the identification information of the goods shelf; acquiring query information of the user visiting the shop; or acquiring the identification information of the user who visits the shop and concerns the shop by scanning a code. The user who concerns the shop by scanning a code is a user who concerns the WeChat official account of the shop by scanning a two-dimensional code on a display screen.

Optionally, in the intelligent speech device 700 of these embodiments, the uploading module 702 is configured to perform at least one of: uploading the time of the user visiting the shop and the identification information of the shop to the cloud based on the time of the user visiting the shop; uploading to the cloud the identification information of the user passing by the goods shelf monitored by the camera, the identification information of the goods shelf and the identification information of the shop, based on the identification information of user visiting the shop and passing by the goods shelf monitored by the camera and identification information of the goods shelf; uploading to the cloud the stay duration of the user who stays before the goods shelf monitored by the camera, the identification information of the user, the identification information of the goods shelf and the identification information of the shop, based on the stay duration of the user who visits the shop and stays before the goods shelf monitored by the camera, the identification information of the user and the identification information of the goods shelf; uploading the query information of the user and the identification information of the shop to the cloud based on the query information of the user visiting the shop; or uploading to the cloud the identification information of the user who concerns the shop by scanning the code and the identification information of the shop, based on the identification information of the user who visits the shop and concerns the shop by scanning the code.

Principles employed by the intelligent speech device 700 of these embodiments to implement the data analysis based on the intelligent speech device by using the above modules and the resultant technical effects are the same as those of the relevant method of the embodiments described with reference to FIG. 2. For particulars, please refer to the depictions of the aforesaid relevant method embodiment, and no detailed depictions will be presented here.

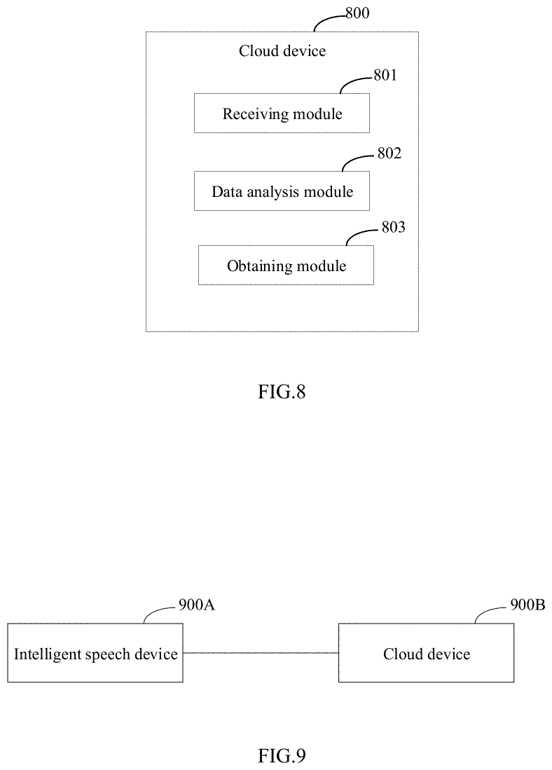

FIG. 8 illustrates a schematic diagram of a cloud device according to some embodiments of the present disclosure. With reference to FIG. 8, a cloud device 800 of these embodiments include: a receiving module 801 configured to receive user data and identification information of a shop uploaded by the intelligent speech device, the user data is uploaded by the intelligent speech device based on acquired feature information of one or more users; and a data analyzing module 802 configured to perform data analysis based on the user data and the identification information of the shop.

Optionally, in the cloud device 800 of these embodiments, the receiving module 801 is configured to perform at least one of: receiving the user's gender and/or age uploaded by the intelligent speech device, as well as the identification information of the shop; receiving a time of the user visiting the shop and the identification information of the shop uploaded by the intelligent speech device; receiving the identification information of a user passing by a goods shelf monitored by the camera, identification information of the goods shelf and the identification information of the shop uploaded by the intelligent speech device; receiving a stay duration of a user before the goods shelf monitored by the camera, the identification information of the user, the identification information of the goods shelf and the identification information of the shop uploaded by the intelligent speech device; receiving the user's query information and the identification information of the shop uploaded by the intelligent speech device; or receiving the identification information of the user who concerns the shop by scanning a code and the identification information of the shop, uploaded by the intelligent speech device.

Optionally, in the cloud device 800 of these embodiments, the data analyzing module 801 is configured to perform at least one of: analyzing gender distribution information of the users visiting the shop within a preset time length, based on the user's gender and the identification information of the shop; analyzing age distribution information of users visiting the shop within the preset time length, based on the user's age and the identification information of the shop; analyzing shop-visiting distribution information of users visiting the shop within the preset time length, based on the time of the user visiting the shop and the identification information of the shop; analyzing the number of users passing by the goods shelf monitored by the camera within the preset time length, based on the identification information of users passing by the goods shelf monitored by the camera, the identification information of the goods shelf and the identification information of the shop; analyzing the number of users staying before the goods shelf within the preset time length based on the stay duration of the user before the goods shelf monitored by the camera, the identification information of the user, the identification information of the goods shelf and the identification information of the shop; wherein the user whose stay duration is greater than a preset duration threshold is determined to be in a stay state; analyzing question distribution information of users visiting the shop within the preset time length, based on the query information of the users and the identification information of the shop; or counting the number of users who visit the shop and concern the shop by scanning a code within the preset time length, based on identification information of the users who concern the shop by scanning the code and the identification information of the shop.

Optionally, the cloud device 800 of these embodiments further include an obtaining module 803; the obtaining module 803 is configured to obtain the operation data of the shop; the data analyzing module 802 is further configured to perform statistics on business data of the shop based on the operation data and the received user data and the identification information of the shop.

Principles employed by the cloud device 800 of these embodiments to implement the data analysis based on the intelligent speech device by using the above modules and the resultant technical effects are the same as those of the relevant method of the embodiments described with reference to FIG. 3. For particulars, please refer to the depictions of the aforesaid relevant method embodiments, and no detailed depictions will be presented here.

FIG. 9 illustrates a schematic diagram of a system according to some embodiments of the present disclosure; with reference to FIG. 9, a data analysis system based on an intelligent speech device of these embodiment include: an intelligent speech device 900A and a cloud device 900B, and the intelligent speech device 900A employs the intelligent speech device shown in FIG. 7, and the cloud device 900B employs the cloud device shown in FIG. 8.

According to some embodiments of the present disclosure, the present disclosure further provides an electronic device and a readable storage medium.

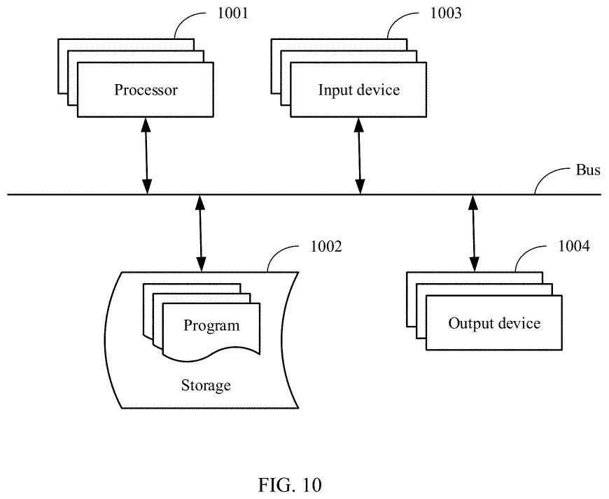

As shown in FIG. 10, it shows a block diagram of an electronic device for implementing a data analysis method based on an intelligent speech device according to embodiments of the present disclosure. The electronic device is intended to represent various forms of digital computers, such as laptops, desktops, workstations, personal digital assistants, servers, blade servers, mainframes, and other appropriate computers. The electronic device is further intended to represent various forms of mobile devices, such as personal digital assistants, cellular telephones, smartphones, wearable devices and other similar computing devices. The components shown here, their connections and relationships, and their functions, are meant to be exemplary only, and are not meant to limit implementations of the inventions described and/or claimed in the text here.

As shown in FIG. 10, the electronic device comprises: one or more processors 1001, a storage 1002, and interfaces connected to components and including a high-speed interface and a low speed interface. Each of the components are interconnected using various busses, and may be mounted on a common motherboard or in other manners as appropriate. The processor can process instructions for execution within the electronic device, including instructions stored in the storage or on the storage device to display graphical information for a GUI on an external input/output device, such as a display device coupled to the interface. In other implementations, multiple processors and/or multiple buses may be used, as appropriate, along with multiple storages and types of storage. Also, multiple electronic devices may be connected, with each device providing portions of the necessary operations (e.g., as a server bank, a group of blade servers, or a multi-processor system). One processor 1001 is taken as an example in FIG. 10.

The storage 1002 is a non-transitory computer-readable storage medium provided by the present disclosure. Wherein, the storage stores instructions executable by at least one processor, so that the at least one processor executes the data analysis method based on the intelligent speech device according to the present disclosure. The non-transitory computer-readable storage medium of the present disclosure stores computer instructions, which are used to cause a computer to execute the data analysis method based on the intelligent speech device according to the present disclosure.

The storage 1002 is a non-transitory computer-readable storage medium and can be used to store non-transitory software programs, non-transitory computer executable programs and modules, such as program instructions/modules corresponding to the data analysis method based on the intelligent speech device according to the present disclosure (e.g., the relevant modules shown in FIG. 7, and relevant modules shown in FIG. 8). The processor 1001 executes various functional applications and data processing of the server, i.e., implements the data analysis method based on the intelligent speech device according to the present disclosure, by running the non-transitory software programs, instructions and units stored in the storage 1002.

The storage 1002 may include a storage program region and a storage data region, wherein the storage program region may store an operating system and an application program needed by at least one function; the storage data region may store data created according to the use of the electronic device for implementing the data analysis method based on the intelligent speech device according to the present disclosure. In addition, the storage 1002 may include a high-speed random access memory, and may also include a non-transitory memory, such as at least one magnetic disk storage device, a flash memory device, or other non-transitory solid-state storage device. In some embodiments, the storage 1002 may optionally include a storage remotely arranged relative to the processor 1001, and these remote memories may be connected to the electronic device for implementing the data analysis method based on the intelligent speech device through a network. Examples of the above network include, but are not limited to, the Internet, an intranet, a local area network, a mobile communication network, and combinations thereof.

The electronic device for implementing the data analysis method based on the intelligent speech device may further include an input device 1003 and an output device 1004. The processor 1001, the storage 1002, the input device 1003 and the output device 1004 may be connected through a bus or in other manners. In FIG. 10, the connection through the bus is taken as an example.

The input device 1003 may receive inputted numeric or character information and generate key signal inputs related to user settings and function control of the electronic device for implementing the data analysis method based on the intelligent speech device, and may be an input device such as a touch screen, keypad, mouse, trackpad, touchpad, pointing stick, one or more mouse buttons, trackball and joystick. The output device 1004 may include a display device, an auxiliary lighting device (e.g., an LED), a haptic feedback device (for example, a vibration motor), etc. The display device may include but not limited to a Liquid Crystal Display (LCD), a Light Emitting Diode (LED) display, and a plasma display. In some embodiments, the display device may be a touch screen.

Various implementations of the systems and techniques described here may be realized in digital electronic circuitry, integrated circuitry, specially designed ASICs (Application Specific Integrated Circuits), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to send data and instructions to, a storage system, at least one input device, and at least one output device.

These computer programs (also known as programs, software, software applications or code) include machine instructions for a programmable processor, and may be implemented in a high-level procedural and/or object-oriented programming language, and/or in assembly/machine language. As used herein, the terms “machine-readable medium” and “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here may be implemented on a computer having a display device (e.g., a CRT (cathode ray tube) or LCD (liquid crystal display) monitor) for displaying information to the user and a keyboard and a pointing device (e.g., a mouse or a trackball) by which the user may provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user may interact with an implementation of the systems and techniques described here), or any combination of such back end, middleware, or front end components. The components of the system may be interconnected by any form or medium of digital data communication (e.g., a communication network). Examples of communication networks include a local area network (“LAN”), a wide area network (“WAN”), and the Internet.

The computing system may include clients and servers. A client and a server are generally remote from each other and typically interact through a communication network. The relationship of client and server arises by virtue of computer programs running on the respective computers and having a client-server relationship to each other.

According to technical solutions of embodiments of the present disclosure, the intelligent speech device acquires feature information of the user visiting the shop; the intelligent speech device uploads user data and the identification information of the shop to the cloud based on the acquired feature information of the user visiting the shop, to help the cloud to perform data analysis based on the user data and the identification information of the shop. As compared with the prior art, the present disclosure can extend the performance of the intelligent speech device so that the intelligent speech device can constitute a business intelligence system with the cloud, achieve analysis of business data and improve an anticipation degree and a use rate of the intelligent speech device.

According to technical solutions of embodiments of the present disclosure, the cloud receives the user data and the identification information of the shop uploaded by the intelligent speech device; the user data is uploaded by the intelligence speech device based on the acquired feature information of the user; the cloud performs data analysis based on the user data and the identification information of the shop. As compared with the prior art, the present disclosure can expand the performance of the intelligent speech device so that the intelligent speech device can constitute a business intelligent system with the cloud to achieve the analysis of the business data and improve the participation degree and use rate of the intelligent speech device.

According to technical solutions of embodiments of the present disclosure, the intelligent speech device may also acquire the user's face image through the camera, use a pre-trained information recognition model to recognize the user's gender and/or age based on the acquired user's face image and upload the user's gender and/or age to the cloud, thereby avoiding directly uploading the user's face image to the cloud and effectively protecting the user's privacy.

According to technical solutions of embodiments of the present disclosure, the cloud may further acquire the shop's operation data; collect statistics of business data of the shop based on the operation data and the received user data and the identification information of the shop, to directly feed back the business data to the shop's intelligent speech device or the shop's account for reference by the shop runner, thereby avoiding introduction of other business systems into the shop and effectively saving the management expenditure of the shop.

It should be understood that the various forms of processes shown above can be used to reorder, add, or delete steps. For example, the steps described in the present disclosure can be performed in parallel, sequentially, or in different orders as long as the desired results of the technical solutions disclosed in the present disclosure can be achieved, which is not limited herein.

The foregoing specific implementations do not constitute a limitation on the protection scope of the present disclosure. It should be understood by those skilled in the art that various modifications, combinations, sub-combinations and substitutions can be made according to design requirements and other factors. Any modification, equivalent replacement and improvement made within the spirit and principle of the present disclosure shall be included in the protection scope of the present disclosure.

What is claimed is:

1. A data analysis method based on an intelligent speech device, comprising:
acquiring, by the intelligent speech device, feature information of a user visiting a shop; and
uploading, by the intelligent speech device to a cloud, user data and identification information of the shop, based on the acquired feature information of the user visiting the shop, so that the cloud performs data analysis based on the user data and the identification information of the shop.

2. The method according to claim 1, wherein uploading by the intelligent speech device to the cloud user data and identification information of the shop based on the acquired feature information of the user visiting the shop comprises:
mining, by the intelligent speech device, the user data according to the acquired feature information of the user visiting the shop; and
uploading, by the intelligent speech device to the cloud, the user data and the identification information of the shop.

3. The method according to claim 2, wherein acquiring by the intelligent speech device feature information of the user visiting the shop comprises:
acquiring, by the intelligent speech device, a face image of the user via a camera;
wherein mining by the intelligent speech device the user data according to the acquired feature information of the user visiting the shop comprises:
recognizing, by the intelligent speech device, the user's gender and/or age, based on the face image of the user with a pre-trained information recognition model; and
wherein uploading by the intelligent speech device to the cloud the user data and the identification information of the shop comprises:
uploading, by the intelligent speech device to the cloud, the user's gender and/or age as well as the identification information of the shop.

4. The method according to claim 1, wherein acquiring by the intelligent speech device feature information of the user visiting the shop comprises at least one of:
acquiring, by the intelligent speech device, a time of the user visiting the shop via the camera;
acquiring, by the intelligent speech device, via the camera, the identification information of the user visiting the shop and passing by a goods shelf monitored by the camera, and the identification information of the goods shelf;
acquiring, by the intelligent speech device, with the camera, a stay duration of the user visiting the shop before the goods shelf monitored by the camera, the identification information of the user and the identification information of the goods shelf;
acquiring, by the intelligent speech device, query information of the user visiting the shop; or
acquiring, by the intelligent speech device, the identification information of the user who visits the shop and concerns the shop by scanning a code, wherein the user who concerns the shop by scanning the code is a user who concerns a WeChat official account of the shop by scanning a two-dimensional code on a display screen.

5. The method according to claim 4, wherein uploading by the intelligent speech device to the cloud user data and identification information of the shop based on the acquired feature information of the user visiting the shop comprises at least one of:
uploading, by the intelligent speech device to the cloud, the time of the user visiting the shop and the identification information of the shop based on the time of the user visiting the shop;
uploading, by the intelligent speech device to the cloud, the identification information of the user passing by the goods shelf monitored by the camera, the identification information of the goods shelf and the identification information of the shop, based on the identification information of the user visiting the shop and passing by the goods shelf monitored by the camera and identification information of the goods shelf;
uploading, by the intelligent speech device to the cloud, the stay duration of the user who stays before the goods shelf monitored by the camera, the identification information of the user, the identification information of the goods shelf and the identification information of the shop, based on the stay duration of the user who visits the shop and stays before the goods shelf monitored by the camera, the identification information of the user and the identification information of the goods shelf;
uploading, by the intelligent speech device to the cloud, the query information of the user and the identification information of the shop, based on the query information of the user visiting the shop; or
uploading, by the intelligent speech device to the cloud, the identification information of the user who visits the shop and concerns the shop by scanning the code and the identification information of the shop, based on the identification information of the user who visits the shop and concerns the shop by scanning the code.

6. A data analysis method based on an intelligent speech device, comprising:
receiving, by a cloud, user data and identification information of a shop uploaded by the intelligent speech device, wherein the user data is uploaded by the intelligent speech device based on acquired feature information of one or more users; and
performing, by the cloud, data analysis based on the user data and the identification information of the shop.

7. The method according to claim 6, wherein receiving by the cloud the user data and identification information of a shop uploaded by the intelligent speech device comprises at least one of:
receiving, by the cloud, a user's gender and/or age uploaded by the intelligent speech device, as well as the identification information of the shop;
receiving, by the cloud, a time of a user visiting the shop and the identification information of the shop uploaded by the intelligent speech device;
receiving, by the cloud, the identification information of a user passing by a goods shelf monitored by the camera, identification information of the goods shelf and the identification information of the shop uploaded by the intelligent speech device;
receiving, by the cloud, a stay duration of a user before the goods shelf monitored by the camera, the identification information of the user, the identification information of the goods shelf, and the identification information of the shop uploaded by the intelligent speech device;
receiving, by the cloud, the query information of a user and the identification information of the shop uploaded by the intelligent speech device; or
receiving, by the cloud, the identification information of a user who concerns the shop by scanning a code and the identification information of the shop uploaded by the intelligent speech device.

8. The method according to claim 7, wherein performing by the cloud data analysis based on the user data and the identification information of the shop comprises at least one of:
analyzing, by the cloud, gender distribution information of users visiting the shop within a preset time length, based on the user's gender and the identification information of the shop;
analyzing, by the cloud, age distribution information of users visiting the shop within the preset time length, based on the user's age and the identification information of the shop;
analyzing, by the cloud, shop-visiting distribution information of users visiting the shop within the preset time length, based on the time of the users visiting the shop and the identification information of the shop;
analyzing, by the cloud, the number of users passing by the goods shelf monitored by the camera within the preset time length, based on the identification information of users passing by the goods shelf monitored by the camera, the identification information of the goods shelf and the identification information of the shop;
analyzing, by the cloud, the number of users staying before the goods shelf within the preset time length based on the stay duration of the user before the goods shelf monitored by the camera, the identification information of the user, the identification information of the goods shelf and the identification information of the shop, wherein the user whose stay duration is greater than a preset duration threshold is determined to be in a stay state;
analyzing, by the cloud, question distribution information of users visiting the shop within the preset time length, based on the query information of the users and the identification information of the shop; or
counting, by the cloud, the number of users who visit the shop and concern the shop by scanning a code within the preset time length, based on identification information of the users who concern the shop by scanning the code and the identification information of the shop.

9. The method according to claim 6, further comprising:
acquiring, by the cloud, operation data of the shop; and
performing, by the cloud, statistics on business data of the shop based on the operation data and the received user data and the identification information of the shop.

10. An electronic device used for an intelligent speech device, comprising:
at least one processor; and
a storage communicatively connected with the at least one processor,
wherein the storage stores instructions executable by the at least one processor, and the instructions are executed by the at least one processor to enable the at least one processor to perform a data analysis method based on an intelligent speech device, which comprises:
acquiring, by the intelligent speech device, feature information of a user visiting a shop; and
uploading, by the intelligent speech device to a cloud, user data and identification information of the shop, based on the acquired feature information of the user visiting the shop, so that the cloud performs data analysis based on the user data and the identification information of the shop.

11. The electronic device according to claim 10, wherein uploading by the intelligent speech device to the cloud user data and identification information of the shop based on the acquired feature information of the user visiting the shop comprises:
mining, by the intelligent speech device, the user data according to the acquired feature information of the user visiting the shop; and
uploading, by the intelligent speech device to the cloud, the user data and the identification information of the shop.

12. The electronic device according to claim 11, wherein acquiring by the intelligent speech device feature information of the user visiting the shop comprises:
acquiring, by the intelligent speech device, a face image of the user via a camera;
wherein mining by the intelligent speech device the user data according to the acquired feature information of the user visiting the shop comprises:
recognizing, by the intelligent speech device, the user's gender and/or age, based on the face image of the user with a pre-trained information recognition model; and
wherein uploading by the intelligent speech device to the cloud the user data and the identification information of the shop comprises:
uploading, by the intelligent speech device to the cloud, the user's gender and/or age as well as the identification information of the shop.

13. The electronic device according to claim 10, wherein acquiring by the intelligent speech device feature information of the user visiting the shop comprises at least one of:
acquiring, by the intelligent speech device, a time of the user visiting the shop via the camera;
acquiring, by the intelligent speech device, via the camera, the identification information of the user visiting the shop and passing by a goods shelf monitored by the camera, and the identification information of the goods shelf;
acquiring, by the intelligent speech device, with the camera, a stay duration of the user visiting the shop before the goods shelf monitored by the camera, the identification information of the user and the identification information of the goods shelf;
acquiring, by the intelligent speech device, query information of the user visiting the shop; or
acquiring, by the intelligent speech device, the identification information of the user who visits the shop and concerns the shop by scanning a code, wherein the user who concerns the shop by scanning the code is a user who concerns a WeChat official account of the shop by scanning a two-dimensional code on a display screen.

14. The electronic device according to claim 13, wherein uploading by the intelligent speech device to the cloud user data and identification information of the shop based on the acquired feature information of the user visiting the shop comprises at least one of:
uploading, by the intelligent speech device to the cloud, the time of the user visiting the shop and the identification information of the shop based on the time of the user visiting the shop;
uploading, by the intelligent speech device to the cloud, the identification information of the user passing by the goods shelf monitored by the camera, the identification information of the goods shelf and the identification information of the shop, based on the identification information of the user visiting the shop and passing by the goods shelf monitored by the camera and identification information of the goods shelf;
uploading, by the intelligent speech device to the cloud, the stay duration of the user who stays before the goods shelf monitored by the camera, the identification information of the user, the identification information of the goods shelf and the identification information of the shop, based on the stay duration of the user who visits the shop and stays before the goods shelf monitored by the camera, the identification information of the user and the identification information of the goods shelf;
uploading, by the intelligent speech device to the cloud, the query information of the user and the identification information of the shop, based on the query information of the user visiting the shop; or
uploading, by the intelligent speech device to the cloud, the identification information of the user who visits the shop and concerns the shop by scanning the code and the identification information of the shop, based on the identification information of the user who visits the shop and concerns the shop by scanning the code.

15. An electronic device used for a cloud, comprising:
at least one processor; and
a storage communicatively connected with the at least one processor,
wherein the storage stores instructions executable by the at least one processor, and the instructions are executed by the at least one processor to enable the at least one processor to perform a data analysis method based on an intelligent speech device, which comprises:
receiving, by the cloud, user data and identification information of a shop uploaded by the intelligent speech device, wherein the user data is uploaded by the intelligent speech device based on acquired feature information of one or more users; and
performing, by the cloud, data analysis based on the user data and the identification information of the shop.

16. The electronic device according to claim 15, wherein receiving by the cloud the user data and identification information of a shop uploaded by the intelligent speech device comprises at least one of:
receiving, by the cloud, a user's gender and/or age uploaded by the intelligent speech device, as well as the identification information of the shop;
receiving, by the cloud, a time of a user visiting the shop and the identification information of the shop uploaded by the intelligent speech device;
receiving, by the cloud, the identification information of a user passing by a goods shelf monitored by the camera, identification information of the goods shelf and the identification information of the shop uploaded by the intelligent speech device;
receiving, by the cloud, a stay duration of a user before the goods shelf monitored by the camera, the identification information of the user, the identification information of the goods shelf, and the identification information of the shop uploaded by the intelligent speech device;
receiving, by the cloud, the query information of a user and the identification information of the shop uploaded by the intelligent speech device; or
receiving, by the cloud, the identification information of a user who concerns the shop by scanning a code and the identification information of the shop uploaded by the intelligent speech device.

17. The electronic device according to claim 16, wherein performing by the cloud data analysis based on the user data and the identification information of the shop comprises at least one of:
analyzing, by the cloud, gender distribution information of users visiting the shop within a preset time length, based on the user's gender and the identification information of the shop;
analyzing, by the cloud, age distribution information of users visiting the shop within the preset time length, based on the user's age and the identification information of the shop;
analyzing, by the cloud, shop-visiting distribution information of users visiting the shop within the preset time length, based on the time of the users visiting the shop and the identification information of the shop;
analyzing, by the cloud, the number of users passing by the goods shelf monitored by the camera within the preset time length, based on the identification information of users passing by the goods shelf monitored by the camera, the identification information of the goods shelf and the identification information of the shop;
analyzing, by the cloud, the number of users staying before the goods shelf within the preset time length based on the stay duration of the user before the goods shelf monitored by the camera, the identification information of the user, the identification information of the goods shelf and the identification information of the shop, wherein the user whose stay duration is greater than a preset duration threshold is determined to be in a stay state;
analyzing, by the cloud, question distribution information of users visiting the shop within the preset time length, based on the query information of the users and the identification information of the shop; or
counting, by the cloud, the number of users who visit the shop and concern the shop by scanning a code within the preset time length, based on identification information of the users who concern the shop by scanning the code and the identification information of the shop.

18. The electronic device according to claim 18, wherein the method further comprises:
acquiring, by the cloud, operation data of the shop; and
performing, by the cloud, statistics on business data of the shop based on the operation data and the received user data and the identification information of the shop.

19. A non-transitory computer-readable storage medium storing computer instructions therein, wherein the computer instructions are used to cause a computer of an intelligent speech device to perform a data analysis method, which comprises:
acquiring feature information of a user visiting a shop; and
uploading user data and identification information of the shop to a cloud, based on the acquired feature information of the user visiting the shop, so that the cloud performs data analysis based on the user data and the identification information of the shop.

20. A non-transitory computer-readable storage medium storing computer instructions therein, wherein the computer instructions are used to cause the computer of a cloud to perform a data analysis method based on an intelligent speech device, which comprises:
receiving user data and identification information of a shop uploaded by the intelligent speech device, wherein the user data is uploaded by the intelligent speech device based on acquired feature information of one or more users; and
performing data analysis based on the user data and the identification information of the shop.
